(19) United States
(12) Patent Application Publication
(10) Pub. No.: US 2026/0088027 A1
(43) Pub. Date: Mar. 26, 2026

(54) ELECTRONIC DEVICE AND VOICE CONTROL METHOD THEREOF

(71) Applicant: ASUS GLOBAL PTE. LTD., Singapore (SG)

(72) Inventors: Jun Teng Wang, Singapore (SG); Sheng Qin, Singapore (SG); Dai Xiang Yuan, Singapore (SG)

(73) Assignee: ASUS GLOBAL PTE. LTD., Singapore (SG)

(21) Appl. No.: 19/213,927

(22) Filed: May 20, 2025

(30) Foreign Application Priority Data
Sep. 24, 2024 (CN) 202411342191.X

(51) Int. Cl. G10L 15/22; G06F 3/16; G10L 15/08

(52) U.S. Cl. CPC G10L 15/22; G06F 3/167; G10L 15/08; G10L 2015/088; G10L 2015/223

(57) ABSTRACT

An electronic device and a voice control method thereof are provided. The method is adapted to the electronic device including a display and a microphone device and includes the following steps. A power-on self-test (POST) procedure of a boot firmware is performed. During the POST procedure, a speech recognition processing is performed to a voice input received by the microphone device to obtain a first voice command. During the POST procedure, a setup interface of the boot firmware is displayed on the display according to the first voice command.

### CROSS-REFERENCE TO RELATED APPLICATION

This application claims the priority benefit of China application serial no. 202411342191.X, filed on Sep. 24, 2024. The entirety of the above-mentioned patent application is hereby incorporated by reference herein and made a part of this specification.

### BACKGROUND

### Technical Field

This disclosure is related to an electronic device and a voice control method thereof.

### Description of Related Art

Generally, when a user wants to access the setup interface of the Unified Extensible Firmware Interface (UEFI), they must manually press a specific hotkey at the right moment during the POST procedure to enter the UEFI setup interface. If the user mistakenly presses the wrong hotkey or forgets the correct one, they will be unable to access the UEFI setup interface successfully. Furthermore, in an era where computer functionalities are becoming increasingly diverse and user demands are more customized, the UEFI setup interface can provide over 300 functional options to meet customer needs. In this context, after entering the UEFI setup interface, users often need to refer to manuals or search online for information to find the specific options and features they truly want to configure in the setup Interface that provides a large number of function options settings. In other words, the operational process for configuring features within the UEFI setup interface is cumbersome and inefficient, leading to user frustration.

### SUMMARY

This disclosure provides a voice control method, adapted to an electronic device including a display and a microphone device. The method includes the following steps. A power-on self-test procedure of a boot firmware is executed. During the power-on self-test procedure, a speech recognition processing is performed on a voice input received by the microphone device to obtain a first voice command. During the power-on self-test procedure, a setup interface of the boot firmware is displayed on the display according to the first voice command.

This disclosure provides an electronic device, which includes a display, a microphone device, a storage device, and a processor. The processor is coupled to the display, the microphone device, and the storage device, and configured to store multiple instructions. The processor is configured to execute the aforementioned instructions to perform the following operations. A power-on self-test procedure of a boot firmware is executed. During the power-on self-test procedure, a speech recognition processing is performed on a voice input received by the microphone device to obtain a first voice command. During the power-on self-test procedure, a setup interface of the boot firmware is displayed on the display according to the first voice command.

Based on the above, in the embodiment of the disclosure, during the POST procedure of the boot firmware, a speech recognition processing may be performed on the voice input received by the microphone device. Therefore, during the process of running the POST procedure of the boot firmware, the setup interface of the boot firmware may be opened according to the user's voice input. As a result, users do not need to memorize the hotkey for accessing the setup interface of the boot firmware, but can efficiently open the setup interface of the boot firmware through voice input, greatly improving operational convenience and user experience.

### BRIEF DESCRIPTION OF THE DRAWINGS

FIG. 1 is a block diagram illustrating an electronic device according to an embodiment of the disclosure.

FIG. 2 is a flowchart illustrating a voice control method according to an embodiment of the disclosure.

FIG. 3 is a block diagram illustrating an electronic device according to an embodiment of the disclosure.

FIG. 4 is a block diagram illustrating an electronic device according to an embodiment of the disclosure.

FIG. 5 is a flowchart illustrating a voice control method according to an embodiment of the disclosure.

FIG. 6A to FIG. 6C are schematic diagrams illustrating a setup interface of boot firmware according to an embodiment of the disclosure.

### DESCRIPTION OF THE EMBODIMENTS

Some embodiments of the disclosure may be described in detail with reference to the accompanying drawings. The component symbols cited in the following description may be regarded as the same or similar components when the same component symbols appear in different drawings. These embodiments are only part of the disclosure and do not disclose all possible implementations of the disclosure. Rather, these embodiments are merely examples of devices and methods within the scope of the patent application of the disclosure.

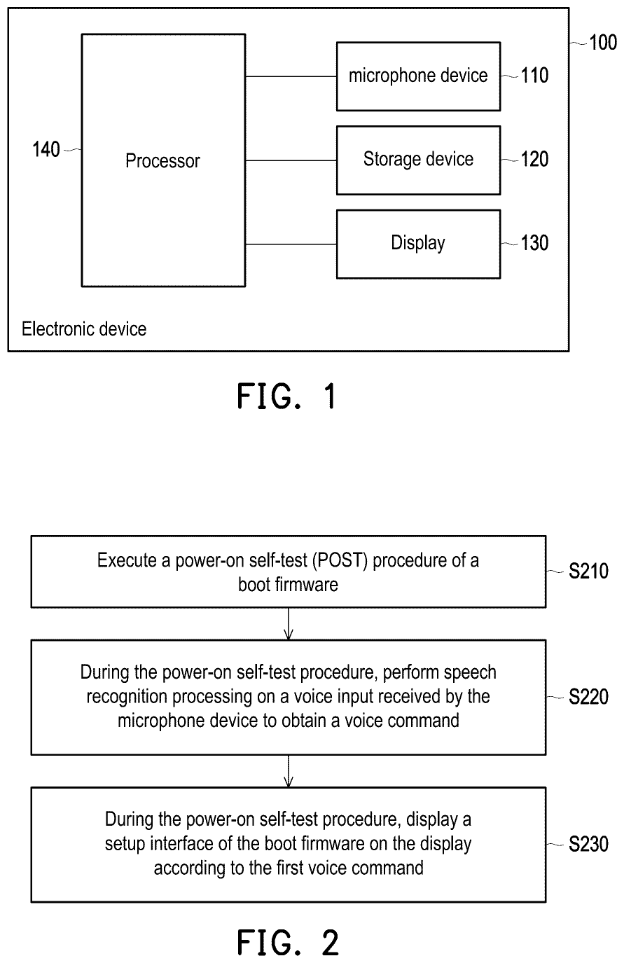

Referring to FIG. 1, in an embodiment of the disclosure, the electronic device 100 may include a microphone device 110, a storage device 120, a display 130, and a processor 140. The electronic device 100 may be a laptop computer, tablet computer, desktop computer, or other computer device equipped with boot firmware, which is not limited in the disclosure.

The microphone device 110 is configured to receive voice input. The microphone device 110 may be a dynamic microphone, condenser microphone, or electret condenser microphone, etc., which is not limited in the disclosure.

The storage device 120 is used to store data and software modules (such as operating systems, applications, drivers) for the processor 140 to access. It may be, for example, any type of fixed or removable random access memory (RAM), read-only memory (ROM), flash memory, hard drive, or a combination thereof.

The display 130 may be, for example, a Liquid Crystal display (LCD), Light-Emitting Diode (LED) display, Organic Light-Emitting Diode (OLED) display, or other types of displays, which is not limited in the disclosure. In an embodiment of the disclosure, the display 130 may display the setup interface of the boot firmware.

The processor 140 is coupled to the microphone device 110, storage device 120, and display 130. The processor 140 may be, for example, a central processing unit (CPU), application processor (AP), or other programmable general-purpose or special-purpose microprocessor, digital signal processor (DSP), image signal processor (ISP), graphics processing unit (GPU) or similar device, integrated circuit, and combinations thereof. The processor 140 may access and execute software modules recorded in the storage device 120 to implement the voice control method in an embodiment of the disclosure. The aforementioned software modules can be broadly interpreted to mean instructions, instruction sets, code, program code, programs, applications, software packages, threads, procedures, Functions, etc., regardless of whether they are called software, firmware, middleware, microcode, hardware description language, or otherwise.

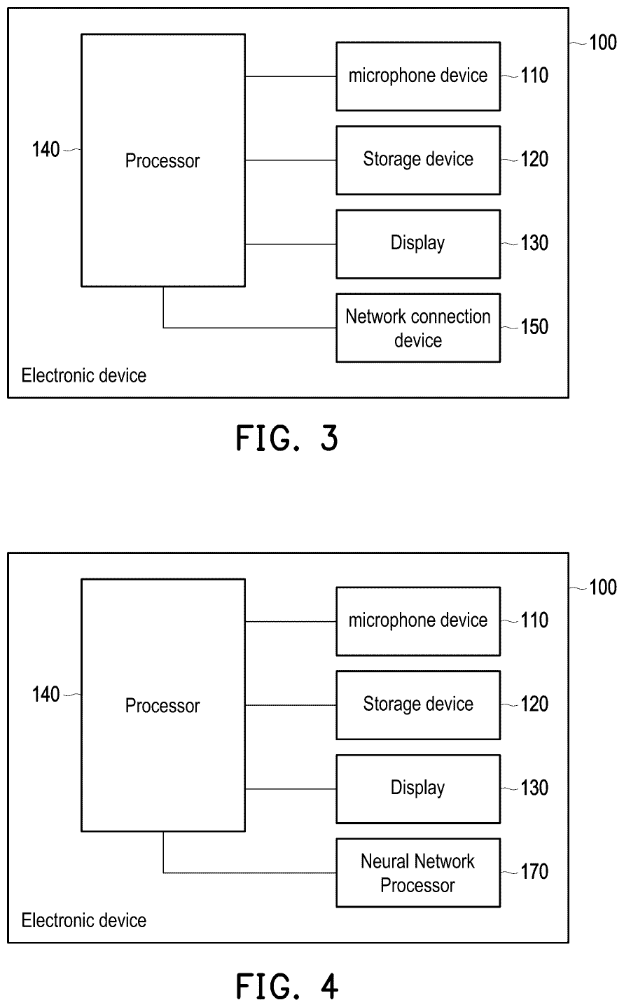

Referring to FIG. 1 and FIG. 2, the method of this embodiment is applicable to the above-mentioned electronic device 100. The following is a detailed description of the voice control method in this embodiment using various components of the electronic device 100.

In step S210, the processor 140 executed a power-on self-test (POST) procedure of a boot firmware. The boot firmware may be recorded in non-volatile Memory (such as read-only Memory or flash Memory). In some embodiments, the boot firmware may be Unified Extensible Firmware Interface (UEFI). Alternatively, in some embodiments, the boot firmware may be the traditional Basic Input/Output System (BIOS).

Specifically, when the electronic device 100 is powered on, the processor 140 may initiate the POST procedure of the boot firmware. The POST procedure is responsible for performing initial configuration and basic test work on various hardware devices of the electronic device 100 to ensure that the electronic device 100 can operate normally. The POST procedure may include multiple stages performed sequentially, such as the Security (SEC) Stage, Pre-EFI Initialization (PEI) Stage, Driver Execution Environment (DXE) Stage, and Boot Device Select (BDS) Stage.

In step S220, during the power-on self-test procedure, the processor 140 performs speech recognition processing on a voice input received by the microphone device 110 to obtain a first voice command. In some embodiments, the processor 140 may provide speech recognition function after completing hardware initialization in the POST procedure, and convert the user's voice input into a voice command. For example, the processor 140 may control some related hardware (such as the microphone device 110, etc.) to implement speech recognition processing after completing hardware initialization in the DXE Stage of the boot firmware. Furthermore, after completing the hardware initialization of some related hardware, the microphone device 100 may receive voice input issued by the user. Afterwards, the processor 140 may perform speech recognition processing on the voice input on its own or by controlling other hardware devices.

In some embodiments, the processor 140 may perform speech recognition processing by calling an external application programming interface (API) through a network. The network may include any combination of public and/or private networks, local area networks and/or wide area networks. Furthermore, the network may utilize one or more wired and/or wireless communication technologies.

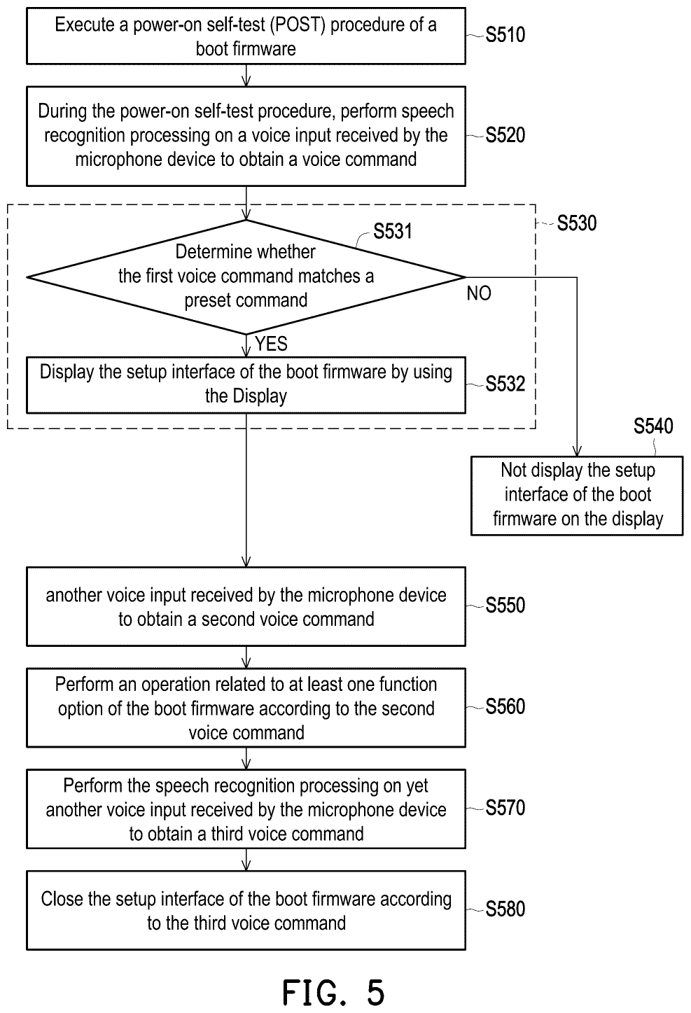

Referring to FIG. 3, the electronic device 100 may also include a network device 150. The network device 150 is used to connect to a network. The network device 150 may connect to a wired network or wireless network, which may include transceivers, antennas and/or other communication Components, etc. During the power-on self-test procedure, the processor 140 may utilize the network device 150 to send the audio data of the voice input to an external voice recognition API. The external voice recognition API receives the audio data and converts it into text by its own voice recognition engine. Then, the processor 140 may utilize the network device 150 to receive the aforementioned text from the external voice recognition API. In this case, the processor 140 may utilize the powerful computing resources and advanced voice recognition technology provided by external services without the need for complex computations on the local device.

In some embodiments, the processor 140 may perform speech recognition processing by executing a speech recognition module embedded in the boot firmware. Specifically, the speech recognition module is a software module that can convert the audio data of voice input into text, which may be embedded in the boot firmware. This speech recognition module is loaded when the electronic device 100 boots up and resides in the non-volatile memory of the electronic device 10 to quickly respond to voice recognition requirements. In this case, the processor 140 does not need a network connection to perform voice recognition, making it suitable for use in scenarios where the network is unstable or high privacy is required.

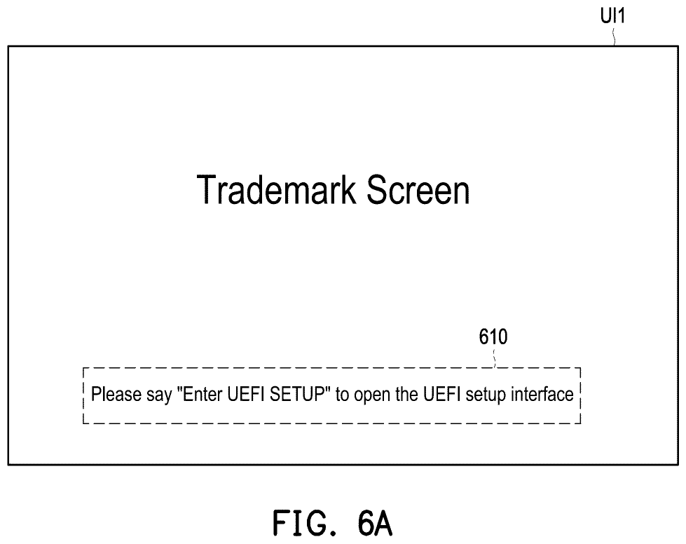

In different embodiments, the speech recognition module embedded in the boot firmware may be executed by the processor 140 itself, or by other computing units with computational capabilities. Referring to FIG. 4, the electronic device 100 may also include a neural network processor 170, also known as a Neural Processing Unit (NPU). In some embodiments, during the power-on self-test procedure, the processor 140 may control the neural network processor 170 to execute the speech recognition module to perform speech recognition processing.

In step S230, during the power-on self-test procedure, the processor 140 displays a setup interface of the boot firmware on the display 130 according to the first voice command. In some embodiments, after obtaining the first voice command, the processor 140 may open the setup interface of UEFI according to the first voice command. The setup interface of UEFI is a graphical User Interface (GUI) and supports mouse operations. The setup interface of the boot firmware may include detailed information about many hardware devices, boot Options, security settings, power management, storage configuration, hardware monitor, and other advanced options. In this way, users do not need to open the setup interface of the boot firmware through a hotkey, but can open the setup interface of the boot firmware during the POST process through voice input.

It should be noted that in the embodiments of this case, since the electronic device 100 may provide speech recognition and voice control functions during the POST process, therefore, in addition to opening the setup interface of the boot firmware through voice input, users may also perform other operations through voice input. The following will illustrate embodiments to clearly explain.

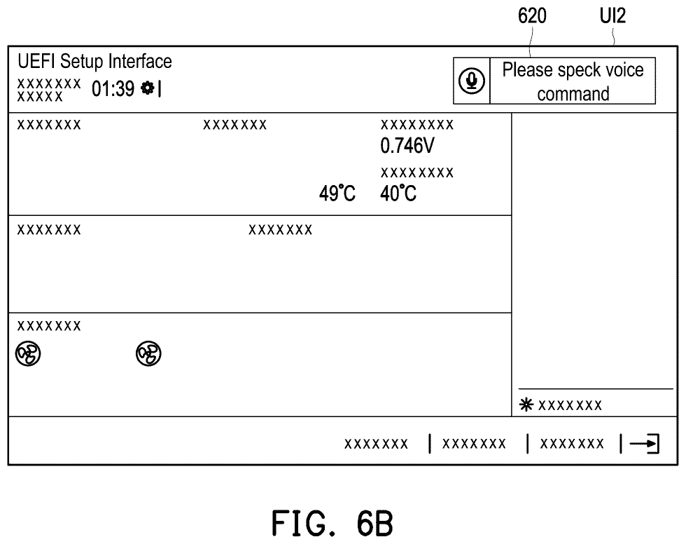

FIG. 5 is a flowchart illustrating a voice control method According to an embodiment of this disclosure. Referring to FIG. 1 and FIG. 5 simultaneously. The method of this embodiment is applicable to the aforementioned electronic device 100. The following will explain the detailed steps of the voice control method of this embodiment in conjunction with various components of the electronic device 100.

In step S510, the processor 140 executes a power-on self-test procedure of a boot firmware. In step S520, during the power-on self-test procedure, the processor 140 performs speech recognition processing on a voice input received by the microphone device 110 to obtain a first voice command. The detailed embodiments of the above steps can be referred to in the previous embodiments explanation, which will not be repeated here.

In step S530, during the power-on self-test procedure, the processor 140 may display a setup interface of the boot firmware on the display 130 according to the first voice command. In this embodiments, step S530 may be implemented as steps S531 to S532.

In step S531, the processor 140 may determine whether the first voice command matches a preset instruction. In step S532, when the first voice command matches the preset instruction (step S531 determined as yes), the processor 140 may display the setup interface of the boot firmware on the display 130. For example, when the processor 140 determines that the first voice command is the preset instruction “Enter UEFI SETUP”, the processor 140 may control the display 130 to display a setup interface of the boot firmware. Conversely, in step S540, when the first voice command does not match the preset instruction (step S531 determined as no), the processor 140 may not display the setup interface of the boot firmware on the display 130.

In some embodiments, the processor 140 may determine whether the first voice command matches a preset instruction by determining whether the first voice command includes keywords of the preset instruction. In some embodiments, the processor 140 may determine whether the first voice command matches a preset instruction based on the similarity between the semantic feature vector of the first voice command and the semantic feature vector of the preset instruction. The aforementioned similarity may be, For example, cosine similarity, Euclidean Distance, or Manhattan Distance, etc. The acquisition of semantic feature vectors can be achieved based on neural network models with semantic analysis capabilities.

Subsequently, in step S550, when displaying the setup interface of the boot firmware on the display 130, the processor 140 performs speech recognition processing on another voice input received by the microphone device 110 to obtain a second voice command. The embodiments for obtaining the second voice command are similar to those for obtaining the first voice command, which will not be repeated here.

In step S560, the processor 140 may perform an operation related to at least one function option of the boot firmware according to the second voice command. In other words, during the period when the setup interface of the boot firmware is displayed, the user may perform operations related to the function options of the boot firmware through voice input. In different embodiments, the processor 140 may search for function options or configure function options settings based on the user's voice input.

In some embodiments, the processor 140 may generate a function search result based on the function search keyword in the second voice command. This function search result includes at least one function option of the boot firmware. Subsequently, the processor 140 may display another setup interface of the boot firmware on the display 130. This other setup interface is configured to present the function search result.

Furthermore, the processor 140 may extract function search keywords from the second voice command and perform a search based on these function search keywords. Subsequently, the processor 140 may control the display 130 to display another setup interface for presenting the function search result. This other setup interface may include one or more function options corresponding to the function search keywords, and this other setup interface may also include graphical User Interface components corresponding to these function options (For example, checkboxes, switches, sliders, or drop-down menus, etc.).

For example, if the processor 140 extracts the function search keyword “fan” from the second voice command, then the processor 140 may perform a search based on the function search keyword “fan” to obtain multiple function options related to “fan” in the UEFI setup interface. The processor 140 the display 130 to display another setup interface that includes the function search result related to “fan”. In this way, the user can quickly find and configure the target function options in UEFI through voice input, without the need to manually browse through numerous options to find the target function options, which can significantly improve operational efficiency.

In some embodiments, when the second voice command includes at least one function option of the boot firmware that matches with a configuration instruction, the processor 140 may perform the configuration operation corresponding to the at least one function option. Furthermore, the processor 140 may determine whether the second voice command includes a configuration instruction, such as “turn off”, “turn on”, “select”, “increase” or “decrease”, etc. Additionally, the processor 140 simultaneously determines whether the second voice command includes function options of the boot firmware. When the second voice command includes a certain function option of the boot firmware and a configuration instruction, the second voice command indicates that the user intends to configure that function options. Therefore, when the second voice command includes at least one function option of the boot firmware and a configuration instruction, the processor 140 may perform the corresponding configuration operation on the function options selected by the user.

For example, when the second voice command is “turn off Function A”, the processor 140 may perform a disable operation on Function A. When the second voice command is “turn on Function B”, the processor 140 may perform an enable operation on Function B. In this way, the user can directly configure UEFI through voice commands without the need for manual operation.

In step S570, the processor 140 may perform speech recognition processing on yet another voice input received by the microphone device 110 to obtain a third voice command. The embodiments for obtaining the third voice command are similar to those for obtaining the first voice command, and will not be repeated here.

In step S580, the processor 140 may closes the setup interface of the boot firmware according to the third voice command. In some embodiments, the processor 140 may determine whether the third voice command matches a preset instruction for closing the setup interface. The detailed embodiments for determining whether the third voice command matches the preset instruction can be referred to the relevant description in step S531, which will not be repeated here. In other words, the user may control the electronic devices 100 to exit the setup interface of the boot firmware through voice input.

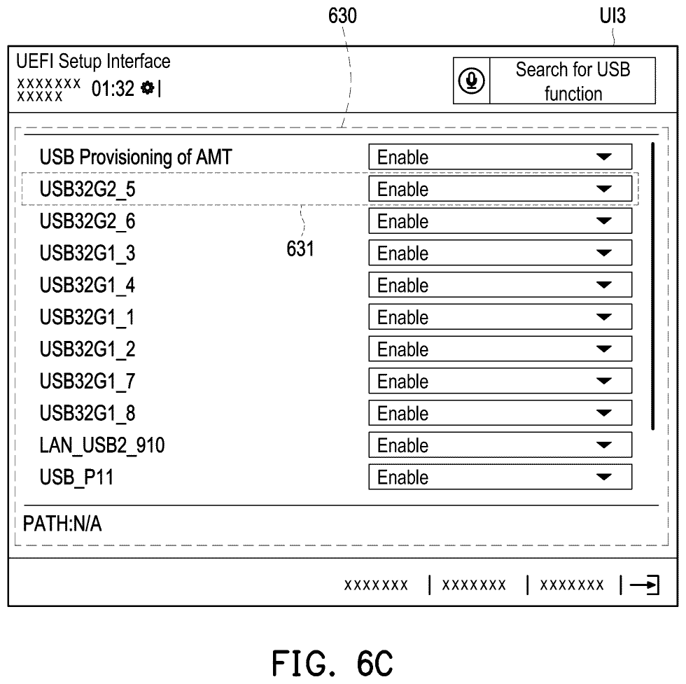

For example, referring to FIG. 6A, the electronic devices 100 may run the POST program after booting. After entering the DXE Stage and completing hardware initialization, the display 130 of the electronic devices 100 may display a trademark screen UI1. This trademark screen UI1 may include a text prompt 610. The text prompt 610 is used to prompt the user that voice input can be used to open the setup interface of UEFI. Next, refer ring to FIG. 6B, when the voice command provided by the user matches the preset instruction for opening the setup interface, the display 130 of the electronic devices 100 may display the setup interface UI2 of UEFI. The setup interface UI2 of UEFI includes a voice input field 620. The voice input field 620 can not only be used to prompt the user that voice input can be used to search for or configure function options of UEFI, but also can be used to display the voice command generated by speech recognition processing. Then, referring to FIG. 6C, assuming the user says “Search for USB Function”, the display 130 of the electronic devices 100 may display the setup interface UI3 of UEFI, and this setup interface UI3 displays a search result list 630 that includes multiple function options related to “USB Function” (such as function options 631).

In summary, in an embodiment of the disclosure, during the running of the power-on self-test procedure of the boot firmware, speech recognition processing can be performed on the voice input received by the microphone device. Therefore, during the running of the power-on self-test procedure of the boot firmware, the setup interface of the boot firmware can be opened according to the user's voice input. Based on this, the user does not need to memorize the hotkey for opening the setup interface of the boot firmware, but can efficiently open the setup interface of the boot firmware through voice input, greatly improving operational convenience and user experience. In addition, the user can also configure or search for function options of the boot firmware through voice input, avoiding time-consuming browsing of irrelevant function options, thereby improving operational efficiency.

Although the present disclosure has been disclosed in the form of embodiments, they are not intended to limit the disclosure. Anyone with ordinary knowledge in the relevant technical field may make slight changes and modifications without departing from the spirit and scope of the disclosure. Therefore, the protection scope of this disclosure shall be determined by the appended patent application scope and its equivalent scope.

What is claimed is:

1. A voice control method, adapted to an electronic device comprising a display and a microphone device, the method comprising:
executing a power-on self-test (POST) procedure of a boot firmware;
during the power-on self-test procedure, performing a speech recognition processing on a voice input received by the microphone device to obtain a first voice command; and
during the power-on self-test procedure, displaying a setup interface of the boot firmware on the display according to the first voice command.

2. The voice control method as claimed in claim 1, wherein the step of during the power-on self-test procedure, displaying the setup interface of the boot firmware on the display according to the first voice command comprises:
determining whether the first voice command matches a preset command; and
when the first voice command matches the preset command, displaying the setup interface of the boot firmware on the display.

3. The voice control method as claimed in claim 2, wherein the step of during the power-on self-test procedure, displaying the setup interface of the boot firmware on the display according to the first voice command further comprises:
when displaying the setup interface of the boot firmware on the display, performing the speech recognition processing on another voice input received by the microphone device to obtain a second voice command; and
performing an operation related to at least one function option of the boot firmware according to the second voice command.

4. The voice control method as claimed in claim 3, wherein the step of performing the operation related to the at least one function option of the boot firmware according to the second voice command comprises:
generating a function search result according to a function search keyword in the second voice command, wherein the function search result comprises the at least one function option of the boot firmware; and
displaying another setup interface of the boot firmware on the display, wherein the another setup interface is configured to present the function search result.

5. The voice control method as claimed in claim 3, wherein the step of performing the operation related to the at least one function option of the boot firmware according to the second voice command comprises:
when the second voice command comprises a configuration instruction and the at least one function option of the boot firmware, performing a setting operation corresponding to the at least one function option.

6. The voice control method as claimed in claim 1, wherein the boot firmware comprises Unified Extensible Firmware Interface (UEFI).

7. The voice control method as claimed in claim 1, wherein the step of during the power-on self-test procedure, performing the speech recognition processing on the voice input received by the microphone device to obtain the first voice command comprises:
performing the speech recognition processing by calling an external application programming interface through a network.

8. The voice control method as claimed in claim 1, wherein the step of during the power-on self-test procedure, performing the speech recognition processing on the voice input received by the microphone device to obtain the first voice command comprises:
performing the speech recognition processing by executing a voice recognition module embedded in the boot firmware.

9. The voice control method as claimed in claim 1, further comprising:
performing the speech recognition processing on yet another voice input received by the microphone device to obtain a third voice command; and
closing the setup interface of the boot firmware according to the third voice command.

10. An electronic device, comprising:
a display;
a microphone device;
a storage device, storing a plurality of instructions; and
a processor, connected to the microphone device and the storage device, configured to execute the instructions to:
execute a power-on self-test (POST) procedure of a boot firmware;
during the power-on self-test procedure, perform a speech recognition processing on a voice input received by the microphone device to obtain a first voice command; and
during the power-on self-test procedure, display a setup interface of the boot firmware on the display according to the first voice command.
